(19) United States
(12) Patent Application Publication
(10) Pub. No.: US 2010/0319034 A1
(43) Pub. Date: Dec. 16, 2010

(54) SYSTEMS AND DEVICES FOR PRESENTING SOCIAL NETWORKING EVENTS VIA A TELEVISION RECEIVER

(75) Inventor: Dale Mountain, West Yorkshire (GB)

Correspondence Address: INGRASSIA FISHER & LORENZ, P.C. (EchoStar), 7010 E. COCHISE ROAD, SCOTTSDALE, AZ, 85253, US

(73) Assignee: ECHOSTAR TECHNOLOGIES LLC, Englewood, CO (US)

(21) Appl. No.: 12/485,611

(22) Filed: Jun. 16, 2009

(51) Int. Cl. H04N 7/20; H04N 7/173; H04N 7/025

(52) U.S. Cl. 725/68; 725/110; 348/468; 348/E07.017

(57) ABSTRACT

Systems and methods provide for presenting updates or events from a social networking website or other community to a viewer on a television. Information describing the event occurring at a social networking community is received at the television receiver. Television imagery that includes television content and also a description of the social networking event is formatted for presentation, and the imagery is presented on the television to thereby provide the description of the social networking event to the viewer via the television.

### TECHNICAL FIELD

This document generally relates to set-top boxes and similar television receivers. More particularly, the following discussion relates to systems and methods for providing information obtained from social networking websites or other communities to television viewers via set-top boxes or other television receiver devices.

### BACKGROUND

Most television viewers now receive their television signals through a content aggregator such as a cable or satellite television provider. Subscribers to a direct broadcast satellite (DBS) service, for example, receive television programming via a broadcast that is sent via a satellite to an antenna that is generally located on the exterior of a home or other structure. Other viewers receive television programming through conventional “over the air” television broadcasts, or through cable, wireless or other media. Programming is typically received at a receiver such as a set top box (STB) or the like that demodulates the received signals and converts the demodulated content into a format that can be presented to the viewer on a television or other display.

More recently, social networking has become much more prevalent among users of the Internet and similar communications networks. Many social networking communities have formed on the Internet and elsewhere. These communities typically allow members to conveniently share messages, pictures, audio files and/or other types information with each other, and often to directly inter-communicate via a chat, voice or other interface.

While a large number of users continue to actively participate in many different social networking communities, at present access to such communities typically requires a computer, mobile phone or similar communications device. There remains a continual desire for improved access to information found on social networking websites and other communities, and it is therefore desirable to obtain access to information from social networking communities across a broader array of settings and devices. These and other desirable features and characteristics will become apparent from the subsequent detailed description and the appended claims, taken in conjunction with the accompanying drawings and this background section.

### BRIEF SUMMARY

According to various exemplary embodiments, systems and methods are provided for presenting updates or events from a social networking website or other community to a viewer on a television.

In various embodiments, a method is performed by a television receiver for presenting imagery to a viewer on a television. The method comprises receiving information at the television receiver, wherein the information describes at least one event occurring at a social networking community. Imagery is formatted by the television receiver for presentation on the television, wherein the imagery includes a description of the event occurring at the social networking community. The presentation of the imagery on the television is directed by the television receiver to thereby provide the description of the event occurring at the social networking community to the viewer via the television.

Further embodiments provide a method performed by a television receiver for notifying a viewer of a television of events occurring at a social networking community operating on a digital communications network. The method receiving an incoming modulated television signal at the television receiver. The incoming modulated television signal is demodulated at the television receiver to obtain demodulated television programming. Information is received at the television receiver via the digital communications network, wherein the information describes at least one event occurring at a social networking community. The imagery is formatted for presentation on the television, wherein the imagery includes a description of the at least one event occurring at the social networking community in combination with the demodulated television programming. The presentation of the formatted imagery on the television is directed by the television receiver to thereby provide the description of the at least one event occurring at the social networking community to the viewer via the television.

Still other embodiments provide a television receiver for notifying a television viewer of events occurring at a social networking community. The television receiver comprises a television interface configured to be coupled to a television, a television programming interface configured to receive an incoming modulated television signal and to demodulate the modulated television signal to extract demodulated television programming, and a controller. The controller is configured to receive information describing at least one event occurring at the social networking community, to format imagery including a description of the event occurring at the social networking community in combination with the demodulated television programming for presentation on the television, and to direct the presentation of the imagery via the television interface to thereby provide the description of the at least one event occurring at the social networking community to the viewer via the television.

Various other embodiments, aspects and other features are described in more detail below.

### BRIEF DESCRIPTION OF THE DRAWING FIGURES

Exemplary embodiments will hereinafter be described in conjunction with the following drawing figures, wherein like numerals denote like elements, and

FIG. 1 is a system diagram of an exemplary television receiver system that is capable of delivering information about social networking events in several different and independently-implementable ways; and

FIG. 2 is a flowchart of an exemplary process for presenting social networking updates to a television viewer.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Information from one or more social networking communities is provided to a television viewer using a set-top box (STB) or similar television receiver. In various embodiments, information relating to an event occurring on a social networking community is received at the television receiver. This information may be processed by the receiver to provide a message or other notifier on the television display so that the viewer becomes aware that the event has occurred. Events that may be relayed to the television viewer may include, for example, information that a friend or other contact has logged into the social networking community; that a person has provided a comment or status update; or any other events as desired. Information may be relayed from the social network to the television receiver in any manner. Various embodiments may incorporate a network interface in the television receiver itself to facilitate direct receipt of social network updates. Other embodiments may use one or more intermediating servers or other facilities to obtain, process and relay social networking information. In still further embodiments, social network updates may be transmitted to the television receiver using a satellite, cable or other connection that is conventionally used for providing television programming. These and other embodiments are described in increasing detail below.

Various embodiments may process updates and other events from any number of social networking community sources. “Social networking community”, in this sense, refers to any Examples of current social network communities include the well-known FACEBOOK, MYSPACE, ORKUT, FRIENDSTER, LINKEDIN and TWITTER services, and many others. Other websites dedicated to social networking communities include NEXOPIA, BEBO, HI5, DOL2DAY, TAGGED, XING, BADOO, SKYROCK, MULTIPLY, WRETCH, XIAONEI and CYWORLD, among many others. Other social networking services are available from providers such as Microsoft Network (MSN), America Online (AOL), Earthlink, Salon.com, Fark.com and many, many others. Other communities may be specially formed solely for subscribers of a television programming aggregator (e.g,. subscribers to a particular satellite or cable television service). Many other communities may be formed using any technologies, and based upon any common interests of users. The following discussion is not limited to any particular social networking community or communities.

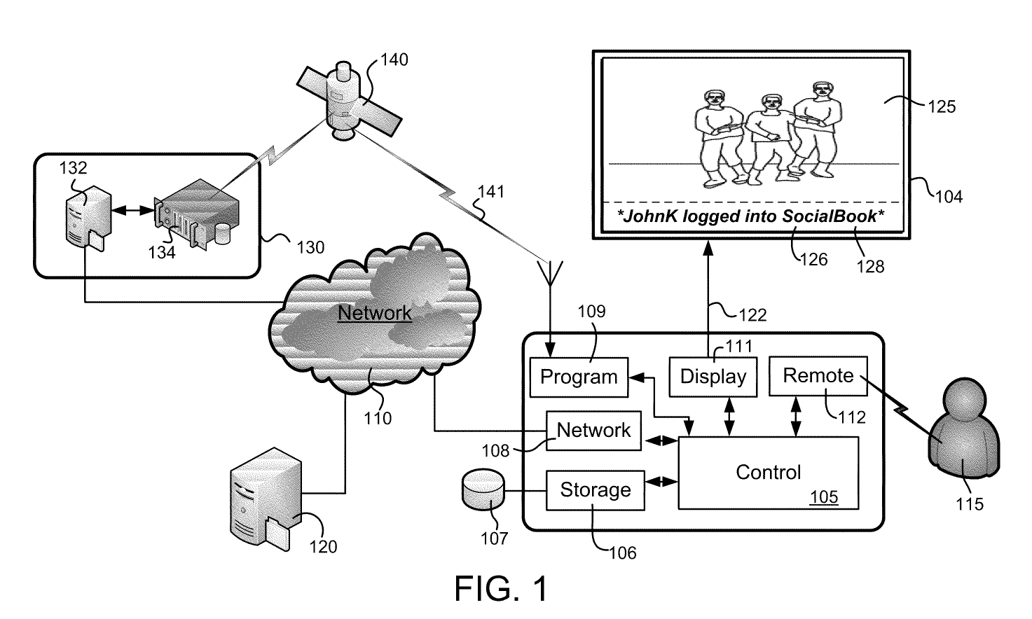

Turning now to the drawing figures and with initial reference to FIG. 1, an exemplary television receiver 102 suitably allows combined viewing of television programming 125 received from a satellite 140, cable or other source with information 126 obtained from a social networking community 120 on a television or other display 104. Social networking information may be obtained directly from a website or other server associated with community 120 on a communications network 110. Alternately, information from community 120 may be received at an intermediary server 132 that receives and processes information from community 120, and then transmits the processed information to receiver 102 via network 110, via programming signals 141, or via any other media as desired. Using any of these techniques, social networking updates or other events can be provided to the television viewer 115 in real time (or substantially in real time). “Substantially” in real time refers to providing updated information to the viewer as the information becomes available, accounting for such inherent delays as network delay, processing delays, and the like. Note that not all embodiments will provide updates in real time; equivalent embodiments may provide updates in a batch mode or “pseudo real time” in which updates are not necessarily processed immediately upon occurence, but rather are polled on a relatively frequent basis (e.g., on the order of every few minutes or so) to improve efficiency and utilization of computing resources.

To that end, television receiver 102 is any type of set-top box (STB), satellite receiver, cable receiver, broadcast receiver, media player and/or other device capable of presenting media signals to a viewer 115 on a display 104. In the exemplary embodiment shown in FIG. 1, receiver 102 suitably includes a controller 105 that interacts with a television programming interface 109 and a television display interface 111 to present imagery to the viewer 115 on display 104. Controller 105 may also interact with a network interface 108, a storage interface 106 and/or a wireless interface 112 as appropriate for the particular embodiment.

Controller 105 is any sort of microprocessor, microcontroller, digital signal processor or other logic capable of directing the actions and processes of receiver 102. In various embodiments, receiver 102 is based upon a “system on chip” (SoC) implementation that incorporates a hybrid microcontroller with memory, input/output and other features to perform the various signal processing and other actions of receiver 102. Various SoC and other integrated hardware implementations are available from Texas Instruments, Conexant Systems, Broadcom Inc., and many other suppliers as appropriate. Other embodiments may implement controller 105 and/or the other features of receiver 102 with any number of discrete and/or integrated processing components (e.g., any sort of microprocessor or microcontroller), memories, input/output features and/or other features as desired.

Programming interface 109 is any receiver, demodulator or other interface capable of receiving television or other media programming as desired. In various embodiments, programming interface 109 is a satellite, cable or broadcast television receiver that tunes, receives and/or demodulates signals 141 received from any appropriate source (e.g., satellite 140 in FIG. 1, although other embodiments may receive signals 141 from cable, broadcast and/or other sources). Programming interface 109 may be logically and/or physically combined with controller 105 in various embodiments, and still other embodiments may not include a separately-identifiable programming interface 109, as appropriate. To that end, the receiving, demodulating and subsequent processing of downlink signals 141 and content contained therein may be processed in any manner, using any processing hardware or other logic.

In embodiments wherein receiver 102 is able to directly communicate on network 110, network interface 108 is any sort of physical, logical and/or other interface to network 110. In various embodiments, network interface 108 includes a conventional wired and/or wireless telephone or network adapter (e.g., a conventional network interface card (NIC) or the like). Interface 108 allows receiver 102 to communicate via any sort of “back channel” with a server 120 and/or the like. In various embodiments, the network interface 108 may be combined with the programming interface 109 in the sense that some types of television or other media programming may be received over network 110, as desired. Some embodiments may not include a back channel and may only provide local data processing, in which case network interface 108 may not be needed or present.

Network 110 is any digital or other communications network capable of routing or otherwise transferring messages between data transmitters (e.g., servers 120, 132) and data receivers (e.g., television receiver 102). In various embodiments, network 110 includes any number of public or private data connections, links or networks supporting any number of communications protocols. Network 110 may include the Internet, for example, or any other network based upon TCP/IP or other conventional protocols. In various embodiments, network 110 could alternately or additionally incorporate a wireless and/or wired telephone network, such as a cellular communications network for communicating with mobile phones, personal digital assistants, and/or the like. Network 110 may also incorporate any sort of wireless or wired local area networks, such as one or more IEEE 802.3 and/or IEEE 802.11 networks. Various embodiments may provide different features that make use of different types of networks 110, as described more fully below.

Display interface 111 is any physical and/or logical interface to display 104. In embodiments wherein display 104 is a conventional television, for example, display interface 111 may provide video output signals 122 in any conventional format, such as component video, S-video, High-Definition Multimedia Interface (HDMI), Digital Visual Interface (DVI), IEEE 1394, and/or any other formats as desired.

Some embodiments may provide DVR or other data storage features, as desired. In such embodiments, storage interface 106 is any sort of physical, logical and/or other interface to any type of internal or external storage device 107. In various embodiments, storage device 107 is a conventional disk drive, although other embodiments may provide mass storage in the form of flash or other memory, optical storage and/or the like. To that end, storage interface 106 may be any sort of conventional serial, parallel or other interface (e.g., peripheral component interconnect (PCI), universal serial bus (USB) and/or the like) capable of facilitating communications between controller 105 and any sort of internal or external storage. Storage device 107 may be used to store programming (e.g., as part of a DVR feature provided by receiver 102), programming instructions executed by controller 105, data (including data associated with any particular viewer 115), and/or other information as appropriate.

Remote interface 112 is any sort of receiver, transceiver or other sort of reader capable of wirelessly or otherwise receiving instructions from a viewer 115 in any manner. In various embodiments, wireless interface 112 includes a conventional infrared receiver that is able to receive commands from a conventional remote control. Other embodiments may not be confined to infrared implementations, but may instead make use of any other short-range wireless signaling techniques such as IEEE 802.15.4 (“ZIGBEE”), IEEE 802.15.1 (“BLUETOOTH”), IEEE 802.11 (“WI-FI”), and/or any other wireless techniques as desired. Interface 112 may also include features for interacting with one or more push buttons, dials or other interface controls on the housing of receiver 102.

In various embodiments, social networking community 120 represents users of a website that is accessible via network 110. To that end, social networking community 120 is generally hosted on a conventional web or other internet server platform that is readily accessible via network 110. In many embodiments, community 120 provides status updates, user comments, imagery, textual content and other user information and the like through documents formatted and transmitted using conventional world wide web and other network constructs. Examples of such constructs used to create social networking documents include hypertext markup language (HTML), extensible markup language (XML), common gateway interface (CGI), personal homepage (PHP) and/or other conventional web technologies as appropriate. Such documents are typically referenced by conventional uniform resource locators (URLs) and transported through a TCP/IP network 110 using hypertext transport protocol (HTML) or the like. Typical users of social network community 120 access documents containing information about events related to the community via a conventional web browser executing on a personal computer or other computing platform.

Receiver 102 obtains information about the social networking community in any manner. In various embodiments, controller 105 and/or network interface 108 is capable of executing a conventional browser program that is able to receive information directly from a website associated with community 120 via network 110. Received documents may be processed to extract information about events in any manner, and this extracted information can be presented to the viewer as information 126. In other embodiments, community 120 provides event updates directly to receiver 102 in a format that is readily understood by receiver 102, thereby reducing or eliminating the need for additional extraction or formatting.

In still other embodiments, however, controller 105 receives data from another server 132 that obtains information from community 120, formats the received information in a manner that is comprehensible to receiver 102, and re-transmits the information to receiver 102 as desired. Server 132 may be, for example, a server associated with a television provider 130 that also provides programming signals 141 to receiver 102 via a satellite 140, cable or other distribution media. To that end, server 132 may transmit social networking information to receiver 102 via network lo and/or via programming signals 141. In the former case, server 132 formats the social networking information into any number of conventional network packets (e.g., as TCP/IP or UDP/IP packets) for transmission on network 110. In the latter case, information intended for any number of television receivers 102 is provided from server 132 to an uplink controller 134 that transmits the information as part of the television programming signal 141. In a conventional direct broadcast satellite implementation, uplink controller 134 associates the information for each receiver 102 that is to receive social networking information with an identifier associated with the particular receiver 102. This information may be, for example, a serial number, digital signature or other code that is recognizable to the particular receiver 102 that receives the information. The combined information is then broadcast on downlink signal 141, and each receiver 102 receiving signal 141 checks the downlink content to determine if there is any content intended for that particular receiver 102. If so, the received information is suitably extracted and processed.

After receiver 102 has obtained television programming and any information about events on social networking community 120, such information may be combined into imagery signal 122 in any manner for presentation to viewer 115 via television display 104. In various embodiments, controller 105 is able to generate alphanumeric or other messages 126 that can overly or otherwise be displayed simultaneously with television programming 125. FIG. 1 shows message 126 as being presented within a window 128 on display 104. This window 128 may be a scrolling alphanumeric “ticker” in some embodiments that allows any amount of information obtained from community 120 to be displayed without unduly blocking the presentation of television content 125. Other embodiments may display information 126 in a “pop up” or other window 128 that may be located anywhere within the displayed imagery. Still other embodiments may not immediately provide the message text describing the event. As an example, some embodiments may not present social networking messages until the viewer depresses a button on the remote control or otherwise indicates a desire to receive such information. Some embodiments may also generate an icon or other relatively non-obtrusive indicator in the displayed imagery to notify the viewer when social networking information is available for display. Other embodiments may present any types or amounts of social networking information in any other manner.

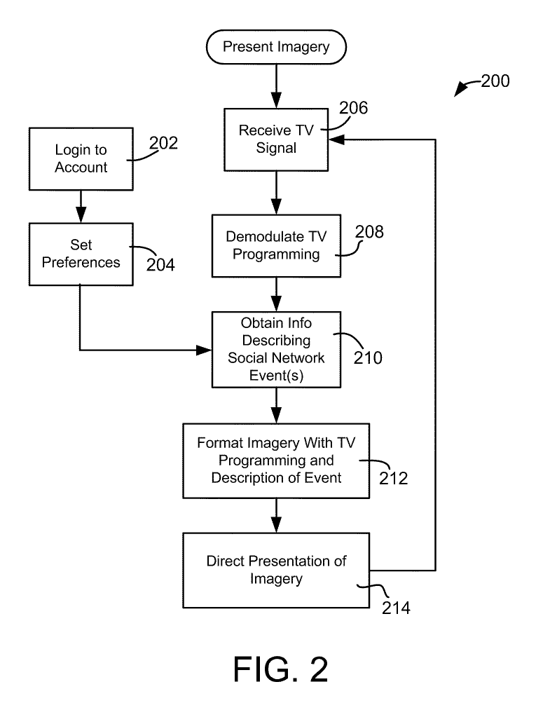

Turning now to FIG. 2, an exemplary method 200 for presenting social network information on a television display suitably includes the broad steps of obtaining information describing one or more social networking events (function 210), formatting imagery that includes both television programming and a description of the social networking event (function 212), and directing the presentation of the imagery on television display 104 (function 214). Various other functions and other features may also be provided, as described in increasing detail below.

Functions 202 and 204 allow the viewer to login to the social networking community 120 (function 202), to initiate communications between community 120 and receiver 102, and/or to set any preferences (function 204) for information that is to be presented on the television display 104. Some embodiments of receiver 102 may include sufficient communications and input/output features to allow the viewer to execute functions 202 and 204 using the receiver 102. In other embodiments, however, the viewer 115 logs into the social community 120 using a separate personal computer, workstation, mobile phone, and/or other computing or communicating device. In still other embodiments, the viewer 115 logs into another server (e.g., server 132) that is able to obtain the viewer's desired information from social networking community 120 and that is able to transmit obtained information to receiver 102, as appropriate.

After authenticating or otherwise logging into the viewer's account with the social networking community 120, the viewer is appropriately able to enable to set any preferences for viewing events occurring within community 120. Such preferences may include, for example, selecting types of events (e.g., other users logging in, making comments, providing status updates, posting pictures and/or the like) to be relayed to receiver 102. Other preferences may include indications of particular users that are of interest (e.g., to allow updates regarding certain friends or other users while ignoring updates for others), particular dates or times that updates should be received (or blocked), or any other information as desired. Such preferences may be stored on server 132 for further processing, although other embodiments may store viewer preference data on receiver 102 (e.g., on storage media 107) or elsewhere.

In many embodiments, receiver 102 receives (function 206) and demodulates (function 208) television programming signals 141 received from any source, and in any format. In a satellite based embodiment, for example, receiver 102 includes a satellite programming interface 109 that is able to tune, receive and demodulate signals 141 received from satellite 140. Other embodiments may process television programming signals 141 received from cable, terrestrial broadcast, and/or other sources as appropriate.

Function 210 in FIG. 2 involves receiving information at the television receiver 102 that describes at least one event occurring at the social networking community 120. As noted above, the “event” may refer to any sort of update or other occurrence, including a user login, a status update, the uploading of images, audio/video files or other data, a comment, or any other events as desired (e.g., “JohnK has logged in.”, “Cristina has commented on your photo.”, “Geeta33 is ready for the weekend!”). The information about the event may be textual, graphical or otherwise in nature. Event information may be encoded in any manner for transmission over network 110 and/or link 141, as noted above.

As noted above, event information may be obtained using any number of different techniques. In some embodiments, receiver 102 has a network interface 108 that receives updates from community 120 via network 110. Such updates may be received directly from a server associated with community 120, or from server 132 or the like. Such updates may be received on any frequency or other temporal basis. Server 120 and/or 132 may provide information in real time (or substantial real time, as defined above) as events occur within community 120. In other embodiments, receiver 120 and/or server 132 polls for events that have occurred in community 120 since the last poll. Poll queries may be issued on any temporal basis; queries may be posited every second or so in some embodiments, every few minutes in others, and more or less frequently in any number of other embodiments.

Event information may be obtained in any format. In some embodiments, server 132 or community 120 provides event information in a format that can be readily understood and processed within receiver 102. In other embodiments, server 132 (or receiver 102) executes a browser-type program that is able to extract desired event information from web pages or other documents obtained from server 120 in any desired manner. Such information may be re-formatted as appropriate for processing by receiver 102.

As noted above, some embodiments may deliver community event updates via programming signals 141 rather than (or in addition to) providing such information over network 110. This may be particularly beneficial in implementations wherein a back channel connection for receiver 102 is not readily available, or in retrofit implementations on receiver hardware that is not capable of conveniently communicating on network lo. Such information may be transmitted over a cable or wireless link to an appropriate receiver 102 using any technique. In various embodiments, event information may be simultaneously broadcast using signals 141 to any number of receivers 102. In such embodiments, information intended for each receiver 102 receiving signals 141 is associated with an identifier prior to broadcast. Each receiver 102 receiving the broadcast is able to identify its intended content by searching for its identifier in the broadcast materials. Other embodiments may supplement or modify this basic concept in any manner.

After television programming and community event information is available to receiver 102, imagery is generated for presentation on television display 104 (function 212). Typically, such information is generated using controller 105 by formatting appropriate on-screen displays that include the viewer's selected television programming, which is demodulated from signals 141, in combination with the textual, graphical or other descriptions of the social networking events. As noted above, descriptions of social networking events may be textual, graphical or otherwise, and may be presented within the generated imagery in any manner (e.g., as text overlying the television programming, in a pop-up or other window, as a scrolling alphanumeric ticker, or in any other manner).

The imagery generated in function 212 may be represented in any sort of imagery signals 122 that are provided to display 104 in any manner. Signals 122 may be in any format that can be received and processed by television display 104. Function 214, then, suitably involves directing the presentation of imagery on television display 104 by generating or otherwise producing signals 122 that can be interpreted by display 104 to produce images that are viewable by viewer 115. As noted above, the imagery presented to the viewer 115 includes both television imagery 125 and descriptions 126 of one or more social network events so that the viewer is kept abreast of developments on social network community 120 while watching television 104.

Generally speaking, the various functions and features of method 200 may be carried out with any sort of hardware, software and/or firmware logic that is stored and/or executed on any platform. Some or all of method 200 may be carried out, for example, by logic executing within receiver 102 operating alone or in conjunction with servers 120 and/or 132 in FIG. 1. In one embodiment, controller 105 executes software logic that performs most of the various functions shown in FIG. 2, with functions 202 and 204 being performed by the viewer using receiver 102 and/or another computing platform (e.g., a personal computer) as appropriate. Functions 206 and/or 208 may be performed by television programming interface 109 in receiver 102 in some embodiments. The particular logic and hardware that implements any of the various functions shown in FIG. 2 may vary from context to context, implementation to implementation, and embodiment to embodiment in accordance with the various features, scenarios and structures set forth herein. The particular means used to implement each of the various functions shown in FIG. 2, then, could be any sort of processing structures that are capable of executing conventional software logic in any format. Such processing hardware may include controller 105 or other components of receiver 102 in FIG. 1, as well as any processors or other components associated with server 120 and/or 132 as appropriate.

Various systems, devices and methods have therefore been described for providing social networking information to a television viewer using a set top box or other television receiver. This allows the television viewer to stay abreast of developments in the social networking community while he or she is watching television, and allows the television viewer to remain connected to social networking events even when he or she is not actively logged into the social networking site using a personal computer, mobile phone or other computing device.

The term “exemplary” is used herein to represent one example, instance or illustration that may have any number of alternates. Any implementation described herein as “exemplary” should not necessarily be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method performed by a television receiver for presenting imagery to a viewer on a television, the method comprising:
receiving information at the television receiver, wherein the information describes at least one event occurring at a social networking community;
formatting the imagery by the television receiver for presentation on the television, wherein the imagery includes a description of the event occurring at the social networking community; and
directing the presentation of the imagery on the television by the television receiver to thereby provide the description of the event occurring at the social networking community to the viewer via the television.

2. The method of claim 1 wherein the receiving comprises receiving the information via a network interface associated with the television receiver.

3. The method of claim 1 wherein the receiving comprises receiving the information via a satellite interface associated with the television receiver.

4. The method of claim 3 wherein the information is contained in a broadcast received via the satellite interface, and wherein the information is associated in the broadcast with an identifier that identifies the television receiver.

5. The method of claim 1 wherein the event corresponds to a user logging into the social networking community, and wherein the description of the event identifies the user.

6. The method of claim 1 wherein the information comprises data obtained from an account on the social networking community that is associated with the viewer.

7. The method of claim 6 wherein the information received at the television receiver is determined at least in part based upon a viewer preference for presenting some of the data obtained from the account while not displaying other data obtained from the account.

8. The method of claim 6 wherein the formatting comprises producing a scrolling alphanumeric ticker as part of the imagery presented on the display, wherein the ticker presents the data obtained from the account on the social networking community on the television.

9. The method of claim 1 wherein the formatting comprises producing the imagery such that the update overlies television programming presented to the viewer on the television.

10. The method of claim 1 wherein the event corresponds to at least one of a status update, a user comment, and an indication that a user has logged in to the social networking community.

11. The method of claim 1 wherein the description of the event occurring at the social networking community is presented to the viewer on the television substantially in real time as the event occurs at the social networking community.

12. A method performed by a television receiver for notifying a viewer of a television of events occurring at a social networking community operating on a digital communications network, the method comprising:
receiving an incoming modulated television signal at the television receiver;
demodulating the incoming modulated television signal at the television receiver to obtain demodulated television programming;
receiving information at the television receiver via the digital communications network, wherein the information describes at least one event occurring at a social networking community;
formatting the imagery for presentation on the television, wherein the imagery includes a description of the at least one event occurring at the social networking community in combination with the demodulated television programming; and
directing the presentation of the formatted imagery on the television by the television receiver to thereby provide the description of the at least one event occurring at the social networking community to the viewer via the television.

13. The method of claim 12 wherein the description of the at least one event occurring at the social networking community is presented to the viewer on the television substantially in real time as the event occurs at the social networking community.

14. A television receiver for notifying a television viewer of events occurring at a social networking community, the television receiver comprising:
a television interface configured to be coupled to a television;
a television programming interface configured to receive an incoming modulated television signal and to demodulate the incoming modulated television signal to extract demodulated television programming;
a controller configured to receive information describing at least one event occurring at the social networking community, to format imagery including a description of the event occurring at the social networking community in combination with the demodulated television programming for presentation on the television, and to direct the presentation of the imagery via the television interface to thereby provide the description of the at least one event occurring at the social networking community to the viewer via the television.

15. The television receiver of claim 14 wherein the information describing the at least one event occurring at a social networking community is received via the television programming interface.

16. The television receiver of claim 14 wherein the information describing the at least one event occurring at a social networking community is contained in a transmission received with the incoming modulated television signal via the television programming interface.

17. The television receiver of claim 16 wherein the transmission received with the incoming modulated television signal is a satellite broadcast.

18. The television receiver of claim 17 wherein the information describing the at least one event occurring at a social networking community is associated in the satellite broadcast with an identifier that identifies the television receiver, and wherein the controller is further configured to extract the information associated with the identifier that identifies the television receiver from the satellite broadcast.

19. The video receiver of claim 14 further comprising a network interface configured to communicate with a digital communications network, wherein the information describing the at least one event occurring at a social networking community is received via the network interface.

20. The video receiver of claim 19 wherein the information is received in a network format from a server associated with the social networking community, and wherein the controller is further configured to produce the description of the event occurring at the social networking community by parsing the network format.
